(19) United States
(12) Patent Application Publication
(10) Pub. No.: US 2008/0106462 A1
(43) Pub. Date: May 8, 2008

(54) Object detection system and object detection method

(75) Inventor: Tatsuya Shiraishi, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/976,031

(22) Filed: Oct. 19, 2007

(30) Foreign Application Priority Data
Nov. 6, 2006 (JP) 2006-300628

(51) Int. Cl. G01S 13/06; G01S 13/93

(52) U.S. Cl. 342/146

(57) ABSTRACT

An object detection system includes a radar detection portion that detects first lateral position information relating to the lateral position of an object with respect to a host vehicle, by transmitting a transmission wave and receiving a reflection wave reflected by the object; an image detection portion that detects second lateral position information relating to the lateral position of the object with respect to the host vehicle, based on the captured image of the object; a distance detection portion that detects a distance between the host vehicle and the object; and a lateral position estimation portion that estimates the lateral position of the object based on the first lateral position information and the second lateral position information. When the lateral position of the object is estimated, the lateral position estimation portion changes each of a weight assigned to the first lateral position information and a weight assigned to the second lateral position information according to the distance.

### INCORPORATION BY REFERENCE

The disclosure of Japanese Patent Application No. 2006-300628 filed on Nov. 6, 2006 including the specification, drawings and abstract is incorporated herein by reference in its entirety.

### BACKGROUND OF THE INVENTION

1. Field of the Invention

The invention relates to an object detection system and an object detection method, in which detection by a radar, and detection based on image are used.

2. Description of the Related Art

For example, Japanese Patent Application Publication No. 2004-233275 (JP-A-2004-233275) describes an object detection system that detects a distance from a host vehicle to a preceding vehicle, and a direction from the host vehicle to the preceding vehicle using a radar device, and calculates the lateral center position of the preceding vehicle with respect to the position of the host vehicle in the vehicle-width direction. The object detection system described in the publication defines in advance a relation between the relative angle of the preceding vehicle with respect to the host vehicle, and a deviation amount, by which the calculated lateral center position deviates from an actual lateral center position, and corrects the calculated lateral center position using the deviation amount determined based on the relative angle. Thus, the detection accuracy is increased.

A radar device generally detects an object by transmitting transmission waves and receiving reflection waves reflected by an object. Thus, it is not possible to determine the reflection position in the object, that is, the position at which the transmission waves are reflected in the object. Therefore, although the radar device accurately detects the lateral center position of a preceding vehicle far from the host vehicle, the radar device provides a less reliable detection result when the preceding vehicle is close to the host vehicle, than when the preceding vehicle is far from the host vehicle. Therefore, in the object detection system, the lateral center position of the preceding vehicle may not be accurately detected when the preceding vehicle is close to the host vehicle, because only the detection result provided by the radar device is used, though correction is made afterward.

### SUMMARY OF THE INVENTION

A first aspect of the invention relates to an object detection system that includes a radar detection portion that detects first lateral position information relating to the lateral position of an object with respect to a host vehicle, by transmitting a transmission wave and receiving a reflection wave reflected by the object; an image detection portion that detects second lateral position information relating to the lateral position of the object with respect to the host vehicle, based on the captured image of the object; a distance detection portion that detects a distance between the host vehicle and the object; and a lateral position estimation portion that estimates the lateral position of the object based on the first lateral position information and the second lateral position information. When the lateral position estimation portion estimates the lateral position of the object, the lateral position estimation portion changes each of a weight assigned to the first lateral position information and a weight assigned to the second lateral position information according to the distance.

In general, a radar accurately detects the lateral position of an object far from the host vehicle. However, the radar provides a less reliable detection result when the object is close to the host vehicle, than when the object is far from the host vehicle, as described above. In contrast, because the sharp image of an object close to the host vehicle is captured, the lateral position of the object close to the host vehicle is accurately detected based on the image. However, when the preceding vehicle is far from the host vehicle, a less reliable detection result is provided based on the image, due to the resolution of a camera, the amount of light, and the like, than when the preceding vehicle is close to the host vehicle.

According to the first aspect, the radar detection portion and the image detection portion are used in combination. The detection accuracy of each of the radar detection portion and the image detection portion varies depending on the distance between the host vehicle and the object. When the lateral position of the object is estimated, it is possible to change each of the weight assigned to the lateral position information detected by the radar detection portion, and the weight assigned to the lateral position information detected by the image detection portion, according to whether the distance between the host vehicle and the object allows the radar detection portion to accurately operate, or the distance allows the image detection portion to accurately operate. Therefore, it is possible to accurately estimate the lateral position of the object with respect to the host vehicle, regardless of the distance between the host vehicle and the object.

A second aspect of the invention relates to an object detection method. The object detection method includes detecting first lateral position information relating to a lateral position of an object with respect to a host vehicle, by transmitting a transmission wave and receiving a reflection wave reflected by the object; detecting second lateral position information relating to the lateral position of the object with respect to the host vehicle, based on a captured image of the object; detecting a distance between the host vehicle and the object; and estimating the lateral position of the object based on the first lateral position information and the second lateral position information. When the lateral position of the object is estimated, each of a weight assigned to the first lateral position information and a weight assigned to the second lateral position information is changed according to the distance.

According to the above-described aspects, it is possible to accurately estimate the lateral position of the object with respect to the host vehicle.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a diagram showing the configuration of an object detection system according to an embodiment of the invention;

FIG. 2 is a flowchart showing steps of a lateral position estimation routine performed by the object detection system according to the embodiment of the invention;

FIGS. 3A and 3B are diagrams showing examples of weighting coefficient maps according to the embodiment of the invention, FIG. 3A showing a weighting coefficient map for a weighting coefficient cc, and FIG. 3B showing a weighting coefficient map for a weighting coefficient β; and

FIG. 4 is a diagram showing a situation where a host vehicle estimates the lateral position of each preceding vehicle, using the object detection system.

### DETAILED DESCRIPTION OF EMBODIMENTS

Hereinafter, an object detection system according to an embodiment of the invention will be described with reference to the accompanying drawings.

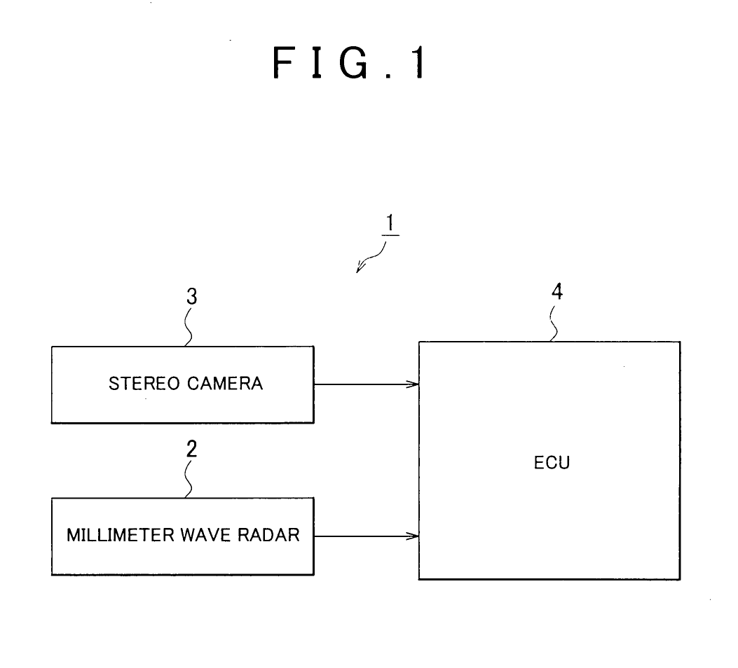

First, the configuration of an object detection system 1 will be described with reference to FIG. 1.

The object detection system 1, provided in a host vehicle, detects an object such as a preceding vehicle that travels ahead of the host vehicle. The object detection system 1 provides object information such as a distance between the host vehicle and the detected object, and the lateral position of the detected object, to a driving support system that requires information relating to the object ahead of the host vehicle, such as a collision avoidance system, an inter-vehicle distance control system, and an adaptive cruise control system. The object detection system 1 includes a millimeter wave radar 2, a stereo camera 3, and an electronic control unit (hereinafter, referred to as “ECU”) 4. The object detection system 1 may be separated from the above-described driving support system, and may transmit the detected object information to the driving support system. Alternatively, the driving support system may include the object detection system 1.

In the embodiment, the millimeter wave radar 2 may be regarded as the radar detection portion and the distance detection portion according to the embodiment. The stereo camera 3 may be regarded as the image detection portion according to the invention. The ECU 4 may be regarded as the lateral position estimation portion according to the invention.

The millimeter wave radar 2 is a radar that detects an object ahead using millimeter waves. The millimeter wave radar 2 is fitted to the front portion of the vehicle at a center position. The millimeter wave radar 2 transmits millimeter waves forward from the host vehicle, and receives the millimeter waves reflected by the rear end portion of the object. Then, the millimeter wave radar 2 calculates a distance from the front end portion of the host vehicle to the rear end portion of the object, by measuring a time from when the millimeter waves are transmitted until when the millimeter waves are received. Also, in the millimeter wave radar 2, a plurality of receiving portions are arranged in a lateral direction. The millimeter wave radar 2 calculates the lateral position of the object with respect to the host vehicle (first lateral position information), based on differences between time points at which the millimeter waves are received at the receiving portions. The lateral position of the object is the position of the center line of the object in a width direction, with respect to the center line of the host vehicle in a vehicle-width direction. The millimeter wave radar 2 is connected to the ECU 4. After the millimeter wave radar 2 calculates the distance between the detected object and the host vehicle, and the lateral position of the detected object as described above, the millimeter wave radar 2 outputs the detection result, i.e., the calculated distance and lateral position to the ECU 4. In the embodiment, the millimeter wave radar 2 calculates the distance and the lateral position. However, the ECU 4 may calculate the distance and the lateral position based on values detected by the millimeter wave radar 2.

Because the millimeter wave radar 2 detects an object by transmitting transmission waves, and receiving reflection waves reflected by the object, it is not possible to determine the reflection position in the object, i.e., the position at which the transmission waves are reflected in the object. Therefore, although the millimeter wave radar 2 accurately detects the lateral position of the preceding vehicle far from the host vehicle, the millimeter wave radar 2 provides a less reliable detection result when the preceding vehicle is close to the host vehicle, than when the preceding vehicle is far from the host vehicle.

The stereo camera 3 includes two CCD cameras (not shown). The two CCD cameras are disposed at an interval of several centimeters in a horizontal direction. The stereo camera 3 is also fitted to the front portion of the host vehicle at the center position. The stereo camera 3 transmits image data captured by each of the two CCD cameras, to an image processing portion (not shown). The image processing portion may be integrally provided in the stereo camera 3, or may be provided in the ECU 4.

The image processing portion detects an object from the image data, and calculates information relating to the position of the object. The image processing portion determines that a peak in the histogram of the image data represents the end portion of the object in the width direction, and derives the lateral position of the object (second lateral position information) by determining the position of the central axis of the object in the width direction based on the determined positions of the both end portions of the object. The image processing portion is connected to the ECU 4. After the image processing portion derives the lateral position as described above, the image processing portion outputs the detection result, i.e., the derived lateral position to the ECU 4.

Because the stereo camera 3 captures the sharp image of the preceding vehicle close to the host vehicle, the stereo camera 3 accurately detects the lateral position of the preceding vehicle close to the host vehicle. However, when the preceding vehicle is far from the host vehicle, the stereo camera 3 provides a less reliable detection result due to the resolution of the stereo camera 3, the amount of light, and the like, than when the preceding vehicle is close to the host vehicle.

The ECU 4 includes a microprocessor, ROM, RAM, and backup RAM. The microprocessor performs calculation. The ROM stores, for example, programs that make the microprocessor perform processing. The RAM stores various data, such as the result of calculation. The backup RAM retains memory content using a 12-volt battery. The ECU 4 with the above-described configuration estimates the lateral position of an object, based on the distance between the host vehicle and the object, and the lateral position of the object, which are obtained from the millimeter wave radar 2, and the lateral position of the object, which is obtained from the stereo camera 3.

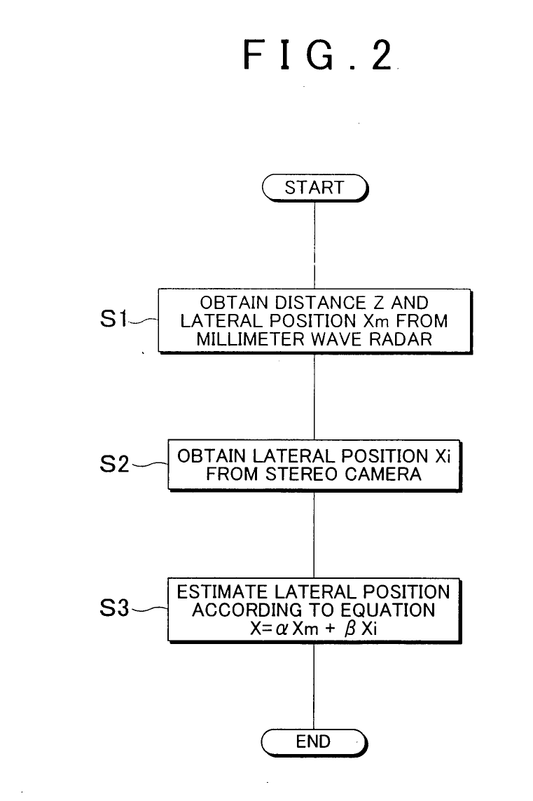

Next, the operation of the object detection system 1 will be described with reference to FIG. 2. FIG. 2 is a flowchart showing the steps of a lateral position estimation routine performed by the object detection system 1. This routine is repeatedly performed by the ECU 4 at predetermined timings during a period from when a power source for the ECU 4 is turned on until when the power source is turned off.

First, the ECU 4 obtains a distance Z from the host vehicle to an object and a lateral position Xm (first lateral position information), which are detected by the millimeter wave radar 2 (S1). Then, the ECU 4 obtains a lateral position Xi of the object (second lateral position information), which is detected by the stereo camera 3 (S2). The lateral position of the object with respect to the host vehicle is given by the position of the center line of the object in the width direction, with respect to the center line of the host vehicle with respect to the vehicle-width direction.

Next, the ECU 4 estimates the lateral position X of the object by changing each of weights assigned to the lateral position Xm and the lateral position Xi, based on the distance Z detected by the millimeter wave radar 2. More specifically, the ECU 4 estimates the lateral position X of the object by summing a lateral position value (first lateral position value) obtained by multiplying the lateral position Xm by a weighting coefficient α (first weighting coefficient), and a lateral position value (second lateral position value) obtained by multiplying the lateral position Xi by a weighting coefficient β (second weighting coefficient) (S3). The weighting coefficient α is used to assign the weight to the detection result provided by the millimeter wave radar 2. The weighting coefficient β is used to assign the weight to the detection result provided by the stereo camera 3. For example, the distance Z and the estimated lateral position X are provided as the object information, to the driving support system such as the collision avoidance system, the inter-vehicle distance control system, and the adaptive cruise control system.

The above-described weighting coefficients α and β are set using two-dimensional maps that define the relations between the distance Z and the weighting coefficients α and β (i.e., weighting coefficient maps). The weighting coefficient maps are stored in the ECU 4. When the ECU 4 obtains the distance Z, the weighting coefficients α and β are set based on the distance Z by referring to the weighting coefficient maps.

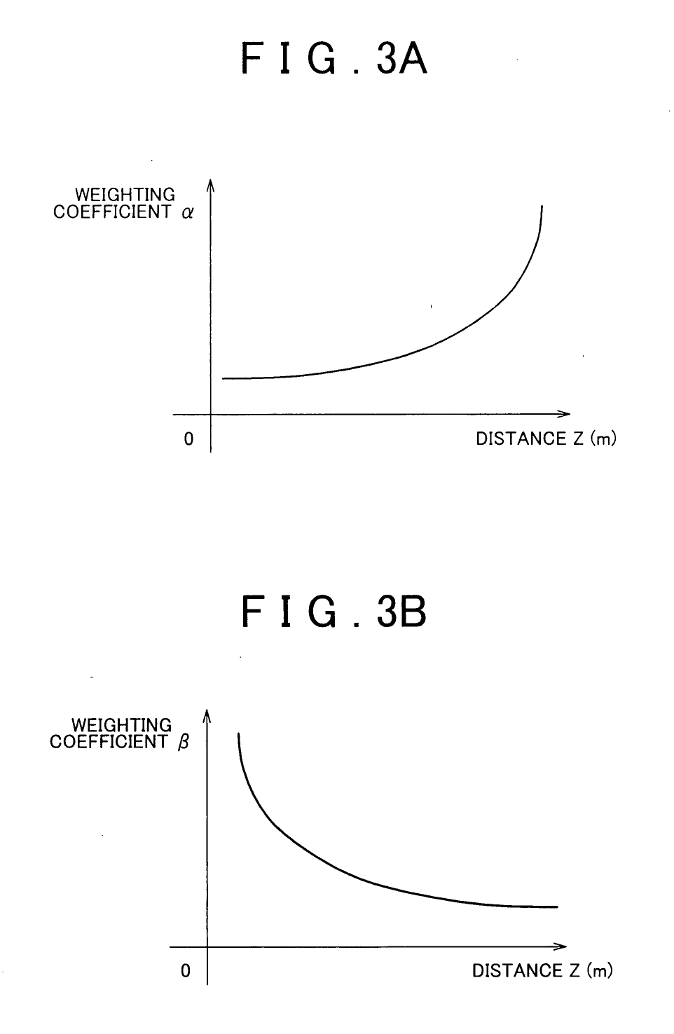

FIG. 3A shows an example of the weighting coefficient map for the weighting coefficient α, and FIG. 3B shows an example of the weighting coefficient map for the weighting coefficient β. As described above, the millimeter wave radar 2 more accurately detects the lateral position of an object, as the object is farther from the host vehicle. The stereo camera 3 more accurately detects the lateral position of an object, as the object is closer to the host vehicle. Therefore, the weighting coefficient map for the weighting coefficient α is set such that as the distance Z increases, that is, as the millimeter wave radar 2 more accurately detects the lateral position, the weighting coefficient α increases. In contrast, the weighting coefficient map for the weighting coefficient β is set such that the distance Z decreases, that is, the stereo camera 3 more accurately detects the lateral position, the weighting coefficient β increases. When the distance Z is approximately 25 meters, the weight assigned to the detection result provided by the millimeter wave radar 2 is substantially equal to the weight assigned to the detection result provided by the stereo camera 3.

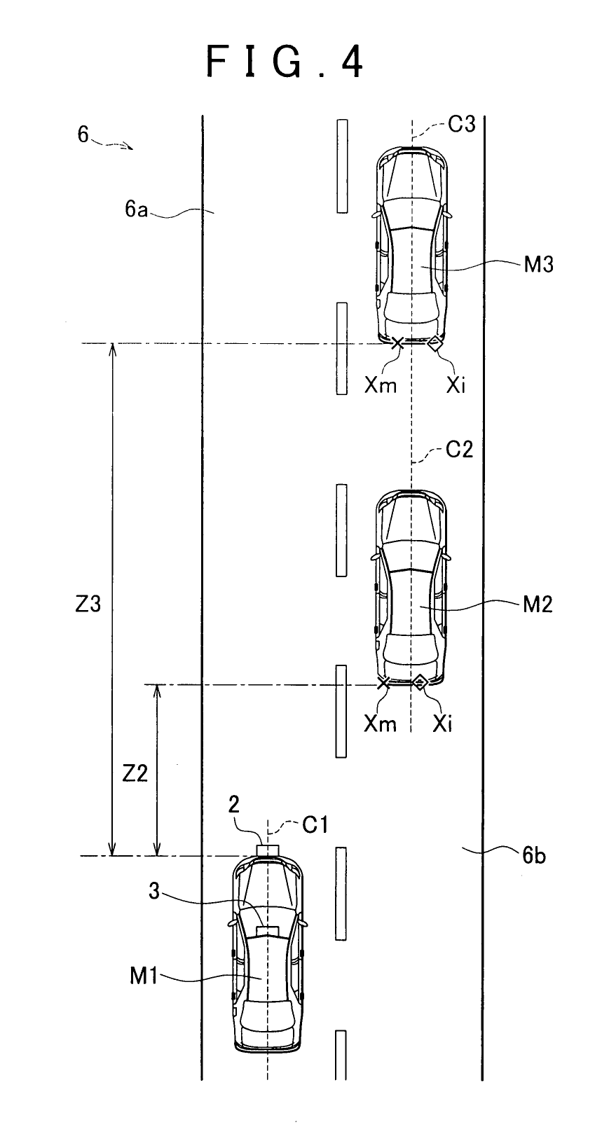

Next, the lateral position estimation routine performed by the object detection system 1 will be described with reference to FIG. 4, using an example where two preceding vehicles travel ahead of a host vehicle on the right. FIG. 4 shows a situation where a host vehicle M1 estimates the lateral position of each of a preceding vehicle M2 and a preceding vehicle M3, using the object detection system 1. In this case, the preceding vehicles M2 and M3 are regarded as the objects ahead of the host vehicle.

The host vehicle M1 detects the distance between the preceding vehicle M2 and the host vehicle M1, and the lateral position of the preceding vehicle M2, using the millimeter wave radar 2 provided in the host vehicle M1. The host vehicle M1 travels in a lane 6a of a road 6. The preceding vehicle M2 travels in an adjacent lane 6b. Also, the host vehicle MI detects the distance between the preceding vehicle M3 and the host vehicle M1, and the lateral position of the preceding vehicle M3, using the millimeter wave radar 2 provided in the host vehicle M1. The preceding vehicle M3 travels in the adjacent lane 6b as well as the preceding vehicle M2. Further, the host vehicle M1 detects the lateral position of each of the preceding vehicles M2 and M3, using the stereo camera 3 provided in the host vehicle M1.

The millimeter wave radar 2 detects the distance Z from the front end portion of the host vehicle M1 to the rear end portion of each preceding vehicle. In FIG. 4, the detected distance from the host vehicle M1 to the preceding vehicle M2 is denoted by Z2, and the detected distance from the host vehicle M1 to the preceding vehicle M3 is denoted by Z3. Also, in FIG. 4, because the preceding vehicle M3 travels ahead of the preceding vehicle M2 when seen from the host vehicle M1, the detected distance Z3 is longer than the detected distance Z2.

The lateral position of the preceding vehicle M2 with respect to the host vehicle M1 is given by the position of the center line C2 of the preceding vehicle M2 in the vehicle-width direction, with respect to the center line C1 of the host vehicle M1 in the vehicle-width direction. The lateral position of the preceding vehicle M3 with respect to the host vehicle is given by the position of the center line C3 of the preceding vehicle M3 in the vehicle-width direction, with respect to the center line C1 of the host vehicle M1 in the vehicle-width direction. In FIG. 4, the lateral position detected by the millimeter wave radar 2 is denoted by Xm. The lateral position detected by the stereo camera 3 is denoted by Xi. As detection accuracy increases, each of the detected lateral positions Xm and Xi is closer to the center line of the preceding vehicle in the vehicle-width direction. As the detection accuracy decreases, each of the detected lateral positions Xm and Xi is farther from the center line of the preceding vehicle in the vehicle-width direction.

Accordingly, as shown in FIG. 4, in the preceding vehicle M2 that travels close to the host vehicle M1, the lateral position Xi detected by the stereo camera 3 is closer to the center line C2 of the preceding vehicle M2 than the lateral position Xm detected by the millimeter wave radar 2 is, because the stereo camera 3 more accurately detects the lateral position of the preceding vehicle M2 than the millimeter radar 2 does. In contrast, in the preceding vehicle M3 that travels far from the host vehicle M1, the lateral position Xm detected by the millimeter wave radar 2 is closer to the center line C3 of the preceding vehicle M3 than the lateral position Xi detected by the stereo camera 3 is, because the millimeter wave radar 2 more accurately detects the lateral position of the preceding vehicle M3 than the stereo camera 3 does.

With regard to the preceding vehicle M2, the weighting coefficient α and the weighting coefficient β are set based on the distance Z2, with reference to the maps shown in FIGS. 3A and 3B. The lateral position X of the preceding vehicle M2 is estimated by summing the lateral position value obtained by multiplying the lateral position Xm by the weighting coefficient α, and the lateral position value obtained by multiplying the lateral position Xi by the weighting coefficient β.

Thus, in the preceding vehicle M2 close to the host vehicle, the weighting coefficient β is set to be larger than the weighting coefficient α. Therefore, the lateral position X of the preceding vehicle M2 is estimated by increasing the weight assigned to the detection result provided by the stereo camera 3 that more accurately detects the lateral position of the preceding vehicle M2 than the millimeter wave radar 2 does.

The lateral position X of the preceding vehicle M3 is estimated in the same manner. Thus, in the preceding vehicle M3 far from the host vehicle, the weighting coefficient α is set to be larger than the weighting coefficient β. Therefore, the lateral position X of the preceding vehicle M3 is estimated by increasing the weight assigned to the detection result provided by the millimeter wave radar 2 that more accurately detects the lateral position of the preceding vehicle M3 than the stereo camera 3 does.

In the embodiment that has been described, the millimeter wave radar 2 and the stereo camera 3 are used in combination. The detection accuracy of each of the millimeter wave radar 2 and the stereo camera 3 varies depending on the distance between the host vehicle and the object. The ECU 4 increases the weight assigned to the detection result provided by the millimeter wave radar 2 when the distance between the host vehicle and the object allows the millimeter wave radar 2 to accurately operate. The ECU 4 increases the weight assigned to the detection result provided by the stereo camera 3 when the distance between the host vehicle and the object allows the stereo camera 3 to accurately operate. Thus, it is possible to accurately estimate the lateral position of the object with respect to the host vehicle, regardless of the distance between the host vehicle and the object.

The invention is not limited to the above-described embodiment. For example, although the millimeter wave radar is used as the radar detection portion in the above-described embodiment, any type of radar may be used. Also, although the stereo camera is used as the image detection portion in the above-described embodiment, any type of camera may be used.

Also, although the millimeter wave radar detects the distance between the host vehicle and the object in the above-described embodiment, the stereo camera may detect the distance.

Further, although the lateral position is the position of the center line of the object in the vehicle-width direction, with respect to the center line of the host vehicle in the vehicle-width direction, in the above-described embodiment, the lateral position may be the position of one end portion of the object in the width direction.

What is claimed is:

1. An object detection system comprising:
a radar detection portion that detects first lateral position information relating to a lateral position of an object with respect to a host vehicle, by transmitting a transmission wave and receiving a reflection wave reflected by the object;
an image detection portion that detects second lateral position information relating to the lateral position of the object with respect to the host vehicle, based on a captured image of the object;
a distance detection portion that detects a distance between the host vehicle and the object; and
a lateral position estimation portion that estimates the lateral position of the object based on the first lateral position information and the second lateral position information,
wherein when the lateral position estimation portion estimates the lateral position of the object, the lateral position estimation portion changes each of a weight assigned to the first lateral position information and a weight assigned to the second lateral position information according to the distance.

2. The object detection system according to claim 1, wherein the lateral position estimation portion increases a first weighting coefficient used to assign the weight to the first lateral position information, as the distance increases, and the lateral position estimation portion increases a second weighting coefficient used to assign the weight to the second lateral position information, as the distance decreases.

3. The object detection system according to claim 2, wherein the first weighting coefficient and the second weighting coefficient are set using a two-dimensional map that defines a relation between the distance and the first weighting coefficient, and a two-dimensional map that defines a relation between the distance and the second weighting coefficient, respectively.

4. The object detection system according to claim 2, wherein the lateral position estimation portion estimates the lateral position of the object by summing a first lateral position value obtained by multiplying the first lateral position information by the first weighting coefficient, and a second lateral position value obtained by multiplying the second lateral position information by the second weighting coefficient.

5. The object detection system according to claim 1, wherein the radar detection portion is a millimeter wave radar.

6. The object detection system according to claim 1, wherein the distance detection portion is a millimeter wave radar.

7. The object detection system according to claim 1, wherein the distance detection portion is a stereo camera.

8. The object detection system according to claim 1, wherein the image detection portion is a stereo camera.

9. A driving support system that includes the object detection system according to claim 1, wherein the driving support system includes at least one of a collision avoidance system, an inter-vehicle distance control system, and an adaptive cruise control system.

10. An object detection method comprising:
detecting first lateral position information relating to a lateral position of an object with respect to a host vehicle, by transmitting a transmission wave and receiving a reflection wave reflected by the object;
detecting second lateral position information relating to the lateral position of the object with respect to the host vehicle, based on a captured image of the object;
detecting a distance between the host vehicle and the object; and
estimating the lateral position of the object based on the first lateral position information and the second lateral position information,
wherein when the lateral position of the object is estimated, each of a weight assigned to the first lateral position information and a weight assigned to the second lateral position information is changed according to the distance.

11. The object detection method according to claim 10, wherein
a first weighting coefficient used to assign the weight to the first lateral position information is increased, as the distance increases, and a second weighting coefficient used to assign the weight to the second lateral position information is increased, as the distance decreases.

12. The object detection method according to claim 11, wherein the lateral position of the object is estimated by summing a first lateral position value obtained by multiplying the first lateral position information by the first weighting coefficient, and a second lateral position value obtained by multiplying the second lateral position information by the second weighting coefficient.

13. An object detection system comprising:
radar detection means for detecting first lateral position information relating to a lateral position of an object with respect to a host vehicle, by transmitting a transmission wave and receiving a reflection wave reflected by the object;
image detection means for detecting second lateral position information relating to the lateral position of the object with respect to the host vehicle, based on a captured image of the object;
distance detection means for detecting a distance between the host vehicle and the object; and
lateral position estimation means for estimating the lateral position of the object based on the first lateral position information and the second lateral position information,
wherein when the lateral position estimation means estimates the lateral position of the object, the lateral position estimation means changes each of a weight assigned to the first lateral position information and a weight assigned to the second lateral position information according to the distance.
